(19) United States
(12) Patent Application Publication
(10) Pub. No.: US 2009/0052707 A1
(43) Pub. Date: Feb. 26, 2009

(54) Hearing-aid system having magnetic-field sensors

(75) Inventor: Jens Hain, Kleinsendelback (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Seimens Audiologische Technik GmbH

(21) Appl. No.: 12/229,328

(22) Filed: Aug. 21, 2008

(30) Foreign Application Priority Data
Aug. 21, 2007 (DE) 10 2007 039 455.3

(51) Int. Cl. H04R 25/00

(52) U.S. Cl. 381/315; 381/323; 381/331

(57) ABSTRACT

A hearing-aid system having two hearing aids that automatic detect a “telephoning” hearing situation and automatic deactivating of the hearing aids on being removed from the head. The hearing aids each include a sensor device to detect if a magnetic field exceeds a specific field strength. Data pertaining thereto can be exchanged between the hearing aids via wireless signals. If a magnetic field is detected by only one of the two hearing aids, then it can be inferred therefrom that the “telephoning” hearing situation applies. If, conversely, both hearing aids detect a magnetic field simultaneously, then both hearing aids are will be deactivated automatically.

### CROSS REFERENCE TO RELATED APPLICATIONS

This application claims priority of German application No. 10 2007 039 0455.3 DE filed Aug. 21, 2007, which is incorporated by reference herein in its entirety.

### FIELD OF INVENTION

The invention relates to a hearing-aid system having a first and second hearing aid that can be worn on or in a user's ear and which each include an input transducer for picking up an input signal and converting it into an electric input signal, a signal-processing unit for processing and amplifying the electric input signal and feeding out an electric output signal, and an output transducer for converting the electric output signal into an output signal that can be perceived by the user as an acoustic signal, with the hearing-aid system further including means for transmitting signals wirelessly between the hearing aids.

The invention relates further to a method for operating a hearing-aid system of such kind.

### BACKGROUND OF INVENTION

Known from EP 0 941 014 A2 is a hearing-aid system that has a first and second hearing aid that can be worn on a user's head and in the case of which signals are transmitted wirelessly between the hearing aids. That enables for example control signals to be transmitted between the hearing aids so that they can both be operated in the same operating mode.

Known from DE 31 09 049 C2 is a hearing aid having a reed contact by means of which a magnetic field having a specific field strength in the immediate vicinity of the hearing aid is detected. That is used to detect whether the hearing aid is in the immediate vicinity of a telephone receiver from which a magnetic field is emanating. The “telephoning” operating mode can thereby be set automatically on the relevant hearing aid.

Known from EP 1 398 994 A2 is a system and a method for selectively coupling hearing devices to an electromagnetic signal. When one hearing device of a hearing-device system having two hearing devices detects that it is receiving a strong inductive signal, then an electromagnetic signal resulting from the inductive signal will be transmitted to the second hearing device of the hearing-device system and, where applicable, further processed by it. It is in particular insured thereby that the inductive signal transmitted to the first hearing device will in the telephoning mode in which only one hearing device of the hearing-device system receives a strong inductive signal be available also in the second hearing device.

### SUMMARY OF INVENTION

To lengthen the useful life of a hearing aid's power source it is expedient to switch the hearing aid off immediately after each use. The user can, though, easily forget to switch off a hearing aid immediately after it has been used. Moreover, only very small control elements can be attached to a hearing aid owing to the miniaturization aimed to be achieved therefore, which makes actuating them and hence also manual switching off difficult.

The object of the present invention is to provide easily realizable and reliable automatic deactivation of the devices in the case of a hearing-aid system of the kind cited in the introduction.

Said object is achieved by means of a hearing-aid system and a method having as claimed in the independent claims.

In a hearing aid, an input signal is picked up by means of an input transducer and transformed into an electric input signal. At least one microphone that picks up an acoustic input signal and converts it into an electric input signal customarily serves as the input transducer. Modern hearing aids frequently include a microphone system having a plurality of microphones in order to achieve a reception dependent on the direction of incidence of acoustic signals: A directivity. Telephone coils or antennas for picking up electromagnetic input signals and converting them into electric input signals are, though, also customary as input transducers. The input signals converted by the input transducer into electric input signals are fed to a signal-processing unit for further processing and amplification. To compensate a user's individual hearing loss they are as a rule further processed and amplified as a function of the input signal's signal frequency. The signal-processing unit supplies at its output an electric output signal that is fed via an output transducer to the hearing-aid wearer's auditory tract in such a way that he/she will perceive the output signal as an acoustic signal. Listening devices that generate an acoustic output signal are customarily employed as output transducers. Known also, however, are output transducers for generating mechanical oscillations that directly stimulate specific parts of the auditory tract such as, for example, the auditory ossicles so that they vibrate. Known further are output transducers that directly stimulate nerve cells in the auditory tract. A hearing aid further includes a power source (non-rechargeable or rechargeable battery) for powering the electronic components. Control elements (on/off switch, program-changeover switch, volume control etc.) can furthermore also be present.

Each hearing aid of the inventive hearing-aid system further includes a signal-transmission and control device by means of which data and control signals can be transmitted between the hearing aids. The signal processing of both hearing aids can thereby be mutually coordinated.

The inventive hearing aids moreover each include a sensor device by means of which the magnetic fields within which the hearing aids are located and which exceed a specific field strength can be registered. The sensor devices are implemented in a particularly simple manner as reed contacts. However, other magnetic-field sensors, for example Hall sensors, also come into consideration. It can be determined by means of the respective sensor device whether the hearing aid is in the immediate vicinity of a telephone receiver from which a detectable magnetic field is emanating so that the hearing aid can be switched where applicable automatically to the “telephoning” operating mode. The sensors' sensitivity is therein dimensioned such that a magnetic field will be detected only if the sensor is in the immediate vicinity of the magnet generating the magnetic field. Consequently only the hearing aid serving the ear to which the telephone is being held will be switched automatically to the telephoning mode. Conversely, the hearing aid serving the other ear will not immediately be switched automatically to the telephoning mode.

With hearing aids it is furthermore desirable that they switch off automatically immediately after use. That can likewise be achieved by means of a sensor device for registering an external magnetic field. If there is a permanent magnet in, for example, a storage box for the relevant hearing aid, then here, too, it can be determined by means of a corresponding sensor device that the hearing aid is in the storage box so that the hearing aid will be switched off automatically. It is furthermore possible for the sensor device to remain active even in the switched-off condition, as a result of which the relevant hearing aid will be enabled to be switched on again automatically after being taken out of the storage box. The sensor device's power consumption in the switched-off condition is very low and so can be ignored.

It will be problematic if both automatic detecting of the “telephoning” hearing situation and automatic deactivating of the hearing aid after being placed in the storage box is desired by the user. That is because on detecting an external magnetic field the sensor device is unable to tell which of the two above-cited situations applies.

Said problem is inventively resolved by transmitting signals wirelessly between the two hearing aids. At least one of the hearing aids therein transmits the information indicating whether an external magnetic field has been detected to the other hearing aid. The latter will hence have the information about the presence of an external magnetic field from both hearing aids. If a telephone receiver from which a magnetic field is emanating is being held to an ear served by a relevant hearing aid, then the magnetic field will owing to the distance between the two hearing aids be detected by that hearing aid only and not by the hearing aid worn in or on the user's other ear. It will hence be determined that the “telephoning” hearing situation applies and to which of the two hearing aids the telephone receiver is being held. If, conversely, both hearing aids detect a relatively strong magnetic field in their immediate surroundings, then that will indicate that the hearing aids are in the storage box and can be switched off.

The invention can be applied to all customary types of hearing aids such as hearing aids that can be worn behind the ear (BTE) and hearing aids that can be worn in the ear (ITE) etc.

### BRIEF DESCRIPTION OF THE DRAWINGS

The invention is explained in more detail below with the aid of an exemplary embodiment:

FIG. 1 shows a hearing-aid system according to the invention and

FIG. 2 is a flowchart for implementing a method according to the invention.

### DETAILED DESCRIPTION OF INVENTION

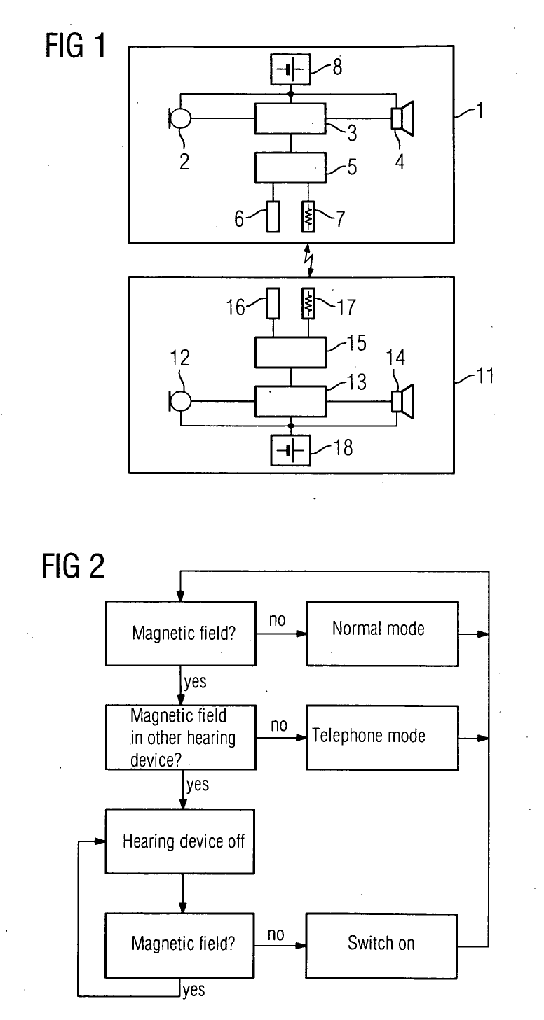

FIG. 1 shows a hearing-aid system having a first hearing aid 1 that can be worn on a user's head and a second hearing aid 11 that can be worn on a user's head. The hearing aids 1 and 11 each include a microphone respectively 2 or 12 for picking up an acoustic input signal and converting it into an electric input signal. A signal-processing unit respectively 3 or 13 serves to process the electric input signal and amplify it frequency-dependently. The electric output signal generated by the signal-processing unit respectively 3 or 13 is converted by a listening device respectively 4 or 14 into an acoustic output signal and fed to a user's auditory tract. Signal processing in the signal-processing units respectively 3 or 13 can be accommodated to different listening environments through the setting of a multiplicity of parameters. There are, for example, listening programs or, as the case may be, operating modes called “speech in quiet surroundings”, “speech in noisy surroundings”, “telephoning” etc. The parameters of the individual listening programs are set and the settings for individually compensating a user's hearing loss are established using the signal-transmission and control units respectively 5 or 15, to which the transmitting and receiving coils respectively 7 or 17 are connected for transmitting data wirelessly, in conjunction with an external programming device (not shown). The status of the reed contacts respectively 6 or 16 can furthermore be interrogated by the signal-transmission and control units respectively 5 or 15. If the reed contacts respectively 6 or 16 are in the immediate vicinity of a magnetic field whose field strength exceeds a specific threshold, then the reed contacts respectively 6 or 16 will close. The corresponding hearing aid will detect therefrom in a simple manner whether it is in the immediate vicinity of a magnet. If either of the two hearing aids respectively 1 or 11 detects in the cited manner that it is located within a magnetic field, then that information will be transmitted to the other hearing aid by means of the signal-transmission and control units respectively 5 or 15 and the transmitting and receiving coils respectively 7 or 17. If a magnetic field is detected by only one of the two hearing aids, then said aid will automatically be put into the “telephoning” operating mode. By means of a corresponding control signal transmitted to the other hearing aid, that, too, can optionally be put into an operating mode matched to that listening situation (“telephone receiver at the opposite ear”).

If, however, a magnetic field is detected by both hearing aids 1 and 11 simultaneously, it can be inferred therefrom that both hearing aids are in a storage box fitted with at least one corresponding magnet. Both hearing aids 1 and 11 will switch off automatically as soon as that situation is detected. A residual power supply by means of which the status of the reed contacts 6 and 16 can continue being interrogated is advantageously maintained also in the switched-off condition. The hearing aids 1 and 11 will as a result detect when they are taken out of the storage box. It will hence also be possible for the hearing aids 1 and 11 to be switched on again automatically. Manually operable on and off switches will consequently be rendered superfluous.

The power sources 8 and 18 for powering the hearing aids 1 and 11 are preferably rechargeable and the storage box for the hearing aids 1 and 11 is advantageously embodied simultaneously as a charging device for the power sources 8 and 18. The hearing aids 1 and 11 will thereby not only be automatically switched off when stored in the storage box; they will also be recharged.

FIG. 2 is a flowchart relating to the automatic detection of the “telephoning” hearing situation and automatic deactivation of two hearing aids of a hearing-aid system according to the invention. One hearing aid of a relevant hearing-aid system therein permanently or cyclically monitors the presence of an external magnetic field. The hearing aid is in “normal mode” as long as no magnetic field is detected. If a magnetic field is detected, then that information will be transmitted to the second hearing aid of the hearing-aid system. The hearing aid furthermore checks whether the other hearing aid of the hearing-aid system is also sending the information that it is located within a magnetic field. If the other hearing aid does not detect a magnetic field, then the hearing aid's signal-processing unit will be put into a telephoning mode in which parameters for controlling signal processing are matched specifically to the “telephoning” hearing situation. An information signal indicating that the first hearing aid is in the “telephoning” operating mode is furthermore transmitted to the second hearing aid. The second hearing aid can then, if applicable, also be put into an operating mode matched to said type of operation.

If it is detected that both hearing aids are located simultaneously within a magnetic field, then that will indicate that the hearing aids are in a storage box fitted with at least one permanent magnet. The hearing aids will thereupon be put into a deactivation mode in which they are for the most part deactivated and only a residual power supply for the sensor device is maintained. As soon as an external magnetic field is no longer being applied, the relevant hearing aid will detect that is has been taken out of the storage box again. It will then instantly switch on automatically.

The hearing aids will through the flow sequence indicated detect in a simple manner both whether they are in the storage box and whether the “telephoning” hearing situation is present. Making that distinction requires just a single magnetic-field sensor in each hearing aid.

1.-5. (canceled)

6. A hearing-aid system, comprising:
a first hearing aid and second hearing aid, each hearing aid is wearable on or in an ear of a user, each hearing aid includes:
an input transducer that picks up an input signal and converting it into an electric input signal,
a signal-processing unit that processes and amplifies the electric input signal and feeds out an electric output signal,
an output transducer that converts the electric output signal into an output signal that is perceived by the user as an acoustic signal,
a sensor device that detects an external magnetic field that exceeds a specific field strength,
a transmitter for transmitting a signal wirelessly between the hearing aids,
wherein data relating to the presence of an external magnetic field detected by at least one of the hearing aids is transmitted to other hearing aid, and
wherein when the sensor device of one of the hearing aid detects a magnetic field while the sensor device of the other hearing aid does not detect a magnetic field the hearing aid detecting the magnetic field is automatically switched to a telephony hearing situation, and
wherein when the sensor device of one of the hearing aid detects a magnetic field while the sensor device of the other hearing aid detects a magnetic field the hearing aids automatically switch off.

7. The hearing-aid system as claimed in claim 6, wherein the sensor device includes a reed contact.

8. The hearing-aid system as claimed in claim 6, wherein the sensor device includes a Hall sensor.

9. The hearing-aid system as claimed in claim 6,
wherein each of the hearing aids include a rechargeable power source, and
wherein the hearing aids automatically switch to an operating mode for recharging the power sources when both sensor devices simultaneously detect a magnetic field.

10. The hearing-aid system as claimed in claim 6,
wherein each of the hearing aids include a rechargeable power source, and
wherein the hearing aids automatically recharge when switched off.

11. A method for operating a hearing-aid system, comprising:
providing a first and second hearing aid each wearable on or in a ear of a user, hearing aid includes:
an input transducer that picks up an input signal and converting it into an electric input signal,
a signal-processing unit processes the electric input signal and generates an electric output signal, and
an output transducer converts the electric output signal into an output signal perceivable by the user as an acoustic signal,
detecting the presence of an external magnetic field that exceeds a specific field strength by at least one of the hearing aids;
wirelessly transmitting data relating to the detected presence of the external magnetic field to the other hearing aid;
automatically switching to a telephony hearing situation when one of the hearing aid detects a magnetic field while the other hearing aid does not detect a magnetic field; and
automatically switching off the hearing devices when each hearing aid detects a magnetic field.
